(19) United States
(12) Patent Application Publication
(10) Pub. No.: US 2026/0181397 A1
(43) Pub. Date: Jun. 25, 2026

(54) SYSTEMS AND METHODS FOR SUBSCRIBER IDENTIFICATION MODULE BASED CALL CONTROL

(71) Applicant: Verizon Patent and Licensing Inc., Basking Ridge, NJ (US)

(72) Inventors: Taussif KHAN, Martinsville, NJ (US); Alexandre DE MELO, Basking Ridge, NJ (US); Lee WHRITENOUR, West Milford, NJ (US); Badar MUNIR, Ashburn, VA (US); Axel HALLO DE WOLF, Whippany, NJ (US)

(73) Assignee: Verizon Patent and Licensing Inc., Basking Ridge, NJ (US)

(21) Appl. No.: 18/989,871

(22) Filed: Dec. 20, 2024

(51) Int. Cl. H04W 12/72; H04W 8/18; H04W 12/08

(52) U.S. Cl. CPC H04W 12/72; H04W 8/18; H04W 12/08

(57) ABSTRACT

In some implementations, a subscriber identification module (SIM) associated with a user equipment (UE) includes one or more components configured to: initialize the SIM during an on power state of the UE, wherein the SIM is associated with a call control application that is disabled; and determine whether to enable the call control application based on one or more conditions being satisfied, wherein the SIM blocks the UE from performing a communication when the call control application is enabled.

### BACKGROUND

Communication systems are widely deployed to provide various telecommunication services such as telephony, video, data, messaging, and broadcasts. A network may include one or more network devices that support communication for wireless communication devices.

### BRIEF DESCRIPTION OF THE DRAWINGS

FIG. 1 is a diagram of an example associated with subscriber identification module (SIM) based call control.

FIG. 2 is a diagram of an example associated with SIM based call control.

FIG. 3 is a diagram of an example environment in which systems and/or methods described herein may be implemented.

FIG. 4 is a diagram of example components of one or more devices of FIG. 3.

FIG. 5 is a flowchart of an example process associated with SIM based call control.

### DETAILED DESCRIPTION OF EXAMPLE EMBODIMENTS

The following detailed description of example implementations refers to the accompanying drawings. The same reference numbers in different drawings may identify the same or similar elements.

An entity, which may include an individual, may initiate an unwanted communication to a recipient. The unwanted communication may include an unwanted voice call and/or an unwanted text message. The unwanted communication may be related to spam, which may involve a legitimate entity attempting to sell a product or service to the recipient. The unwanted communication may be related to a scam, which may involve an impersonation of a legitimate entity in order to defraud the recipient. The entity that initiates the unwanted communication may be a spammer, a scammer, and/or a fraudster.

The unwanted communication may be made using a prepaid subscriber identification module (SIM) card, which may allow the entity to remain anonymous. The prepaid SIM card may not require a same level of identification or personal information as a traditional account, so the entity may use the prepaid SIM card to hide a personal identity. The prepaid SIM card may make it difficult to trace a source of the unwanted communication. The prepaid SIM card may be used for the unwanted communication due to anonymity, disposability, and/or low cost. The prepaid SIM card may be purchased without requiring personal identification, making it easier for the entity to remain anonymous. The prepaid SIM card may be easily discarded or switched out after making a series of unwanted communications, which may allow the entity to avoid detection and blocking. The prepaid SIM card may be inexpensive, so the entity may make a large volume of unwanted communications without significant cost. The entity may purchase prepaid SIM cards in bulk, obtain service without providing personal details (e.g., verifiable details), and use those lines to make the unwanted communications.

An unwanted communication may be made by the entity using a SIM box. The SIM box may be a device that holds a plurality of prepaid SIM cards and/or a plurality of modems. For example, the SIM box may include 512 prepaid SIM cards and 16 modems. The SIM box may be used to route the unwanted communication, which may appear to be coming from a local or domestic phone number. The SIM box may allow for numerous unwanted communications to be launched in a simultaneous manner.

Unwanted communications using the prepaid SIM card and/or the SIM box may waste system resources. For example, the unwanted communications may waste compute resources, network resources, and/or storage resources. The unwanted communications may create an undesirable strain on a wireless communication network, which may affect a performance of legitimate communications (e.g., legitimate voice calls and/or legitimate text messages), thereby degrading an overall system performance.

In some implementations, a user equipment (UE), which may include a SIM box, may be powered on with a SIM. By default, the SIM may include a call control application that is disabled. The call control application, when enabled, may allow the SIM to block the UE from performing certain communications (e.g., voice calls and/or text messages). Depending on a usage pattern associated with the UE, the UE may be flagged by a server, such as a mobile telephony application server (MTAS). For example, when the usage pattern indicates that the UE has performed a number of communications within a time period that satisfies a threshold, the UE may be flagged as being suspicious. In this example, the call control application may be enabled on the SIM. When the call control application is enabled and the SIM receives a request to perform a communication (e.g., a voice call or a text message), the SIM may block the request, which may prevent the UE from performing the communication. When a user of the UE is a fraudulent user, the user may stop using the UE. When a user of the UE is a legitimate user that was flagged by mistake, the user may instruct the UE to contact a network device associated with customer care, which may disable the call control application when certain criteria are met (e.g., when the user produces sufficient evidence to show that the user is legitimately using the UE).

In some implementations, by enabling the call control application on the SIM to be enabled and/or disabled depending on the usage pattern, the SIM may be prevented from being used to make unwanted communications (e.g., unwanted spam/scam voice calls and/or text messages). Enabling the call control application based on the usage pattern (e.g., when the number of communications within the time period satisfies the threshold) may cause the UE to be blocked from communicating with other UEs, which may increase a likelihood that the SIM will be discarded and not used to make the unwanted communications. As a result, a reduction in unwanted communications may reduce system resources. The reduction in unwanted communications may reduce a strain on a wireless communication network, which may improve a performance of legitimate communications, thereby improving an overall system performance.

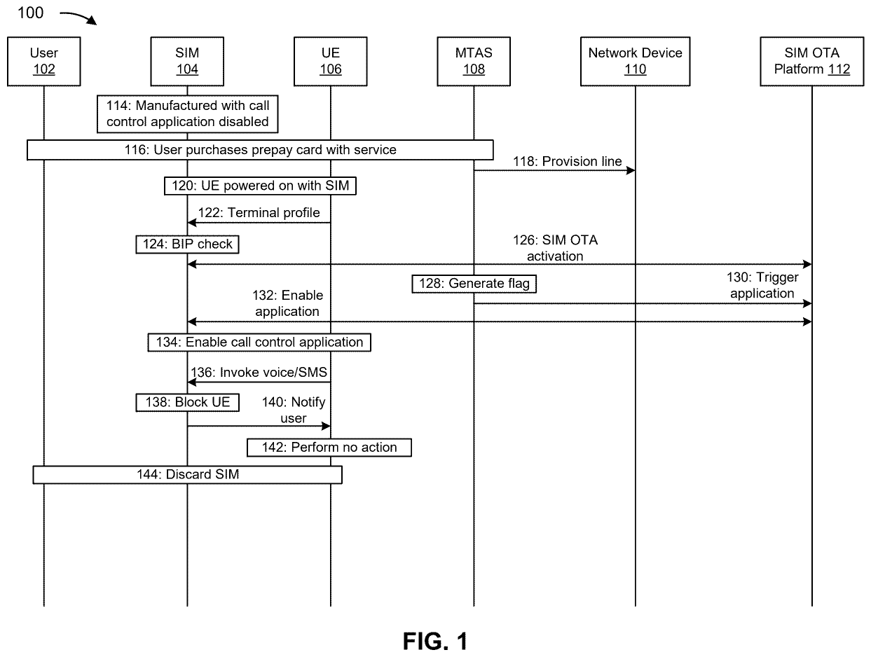

FIG. 1 is a diagram of an example 100 associated with SIM based call control. As shown in FIG. 1, example 100 includes a SIM 104, a UE 106 (or multiple UEs 106), an MTAS 108, a network device 110, and a SIM over-the-air (OTA) platform 112. The SIM 104 may be associated with the UE 106. The SIM 104 and/or the UE 106 may be associated with a user 102. The SIM 104 may or may not be associated with a SIM box. The SIM 104 may be a prepaid SIM.

As shown by reference number 114, the SIM 104 may be manufactured with a call control application disabled. The call control application may be associated with a SIM based call control logic. The call control application, which may run on the SIM 104, may allow the SIM 104 to block the UE 106 from performing certain communications. The call control application, when enabled, may allow the SIM 104 to block the UE 106 from performing certain communications. For example, the call control application may allow the SIM 104 to block the UE 106 from performing voice calls. As another example, the call control application may allow the SIM 104 to block the UE 106 from transmitting text messages. In these examples, the UE 106 may send a request to the SIM 104 prior to attempting such communications, and in response to the request, the SIM 104 may indicate to the UE 106 that the UE 106 is not permitted to perform such communications. By default, the call control application may be disabled, so the SIM 104 may allow the UE 106 to perform certain communications.

As shown by reference number 116, the SIM 104 may be purchased by the user 102. The SIM 104 may support a prepaid mobile service (e.g., voice calls and/or text messaging). As shown by reference number 118, the MTAS 108 may transmit signaling to the network device 110 in order to provision a line for the SIM 104. As shown by reference number 120, the UE 106 may be powered on with the SIM 104. In other words, the SIM 104 may be associated with the UE 106 and then the UE 106 may be powered on. As shown by reference number 122, the UE 106 may provide profile (e.g., terminal profile) information to the SIM 104.

As shown by reference number 124, the SIM 104 may perform a bearer independent protocol (BIP) check. The BIP check may correspond to a communication protocol between the SIM 104 and the SIM OTA platform 112. The BIP check may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 126, the SIM 104 may perform a SIM OTA activation with the SIM OTA platform 112, which may be based on the BIP check. In this case, the SIM 104 may be able to communicate with the SIM OTA platform 112, which may be indicated by the BIP check.

As shown by reference number 128, the MTAS 108 may generate a flag, which may be in response to the SIM 104 being used on a certain number of voice calls and/or text messages within a certain time period. For example, the SIM 104 may be used to perform 800 voice calls in one day, which may cause the flag to be generated. The MTAS 108 may generate the flag based on the pattern based network detection. The SIM 104 may report, to the MTAS 108 and/or the network device 110, when the SIM 104 is being used to make a voice call or send a text message, which may allow the MTAS 108 to detect the certain number of voice calls and/or text messages within the certain time period and then generate the flag. The flag may indicate that the SIM 104 is potentially being used for unwanted behavior (e.g., making unwanted communications).

In some implementations, the flag may be generated based on other conditions being met. For example, the flag may be generated when the SIM 104 is used to perform communications during a certain time of day, communications to users in a certain geographical area, and/or communications to users having the same area code. In such scenarios, the MTAS 108 may consider the communications made by the UE 106 to be suspicious, which may cause the MTAS 108 to generate the flag.

As shown by reference number 130, the MTAS 108 may transmit, to the SIM OTA platform 112, application trigger signaling, and as shown by reference number 132, the SIM OTA platform 112 may transmit, to the SIM 104 and based on the application trigger signaling, an application enabled signaling. As shown by reference number 134, the call control application may be enabled on the SIM 104, which may be based on SIM wakeup invoked signaling. The call control application may serve to block subsequent communications (e.g., voice calls and/or text messages) by the UE 106, which may be based on an assumption that the subsequent communications are spam and/or scam related communications.

As shown by reference number 136, the SIM 104 may receive, from the UE 106, an invoke voice or short message service (SMS) (text) signaling, which may be based on a communication (e.g., an intended voice call or text message) to be initiated by the UE 106. As shown by reference number 138, the SIM 104 may block the UE 106 from performing the communication, which may be based on the call control application being enabled on the SIM 104. The SIM 104 may block the UE 106 from performing the communication based on the assumption that the UE 106 is associated with fraudulent activity. As shown by reference number 140, the SIM 104 may send, to the UE 106, a notification that the communication has been blocked. As shown by reference number 142, the UE 106 may perform no further action. For example, when the user 102 of the UE 106 is a fraudulent user, the user 102 may perform no further action using the UE 106. As shown by reference number 144, the SIM 104 may be discarded, which may be due to the SIM 104 no longer being useable for performing the fraudulent activity. In this example, the SIM 104 may no longer be used to make unwanted communications. Since the SIM 104 may be the prepaid SIM, discarding the SIM 104 with presumably remaining funds may be undesirable from the perspective of the fraudulent user.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

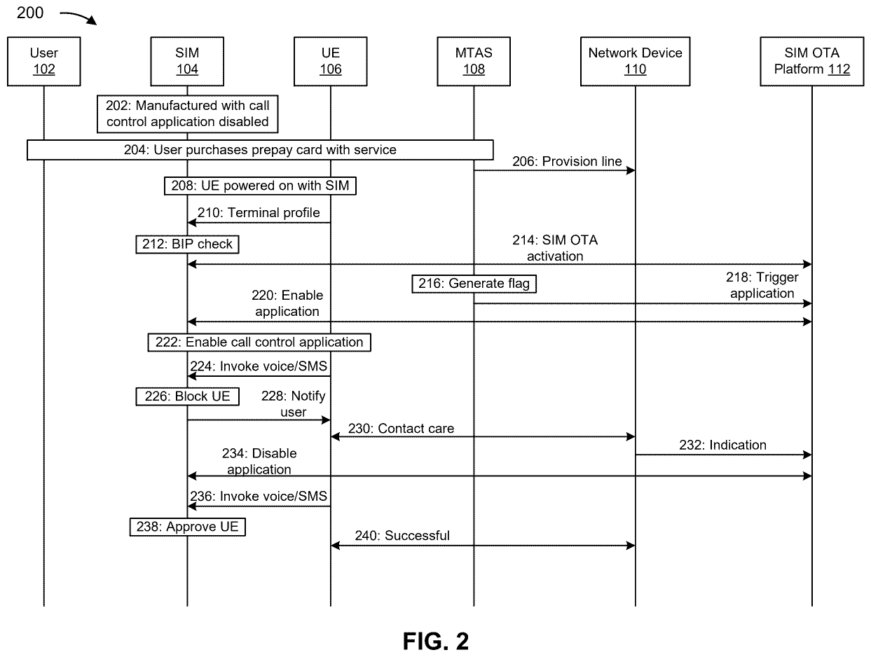

FIG. 2 is a diagram of an example 200 associated with SIM based call control. As shown in FIG. 2, example 200 includes a SIM 104, a UE 106, an MTAS 108, a network device 110, and a SIM OTA platform 112. The SIM 104 may be associated with the UE 106. The SIM 104 and/or the UE 106 may be associated with a user 102. The SIM 104 may or may not be associated with a SIM box. The SIM 104 may be a prepaid SIM.

As shown by reference number 202, the SIM 104 may be manufactured with a call control application disabled. The call control application may be associated with a SIM based call control logic. The call control application, which may run on the SIM 104, may allow the SIM 104 to block the UE 106 from performing certain communications. The call control application, when enabled, may allow the SIM 104 to block the UE 106 from performing certain communications. For example, the call control application may allow the SIM 104 to block the UE 106 from performing voice calls. As another example, the call control application may allow the SIM 104 to block the UE 106 from transmitting text messages. In these examples, the UE 106 may send a request to the SIM 104 prior to attempting such communications, and in response to the request, the SIM 104 may indicate to the UE 106 that the UE 106 is not permitted to perform such communications. By default, the call control application may be disabled, so the SIM 104 may allow the UE 106 to perform certain communications.

As shown by reference number 204, the SIM 104 may be purchased by the user 102. The SIM 104 may support a prepaid mobile service (e.g., voice calls and/or text messaging). As shown by reference number 206, the MTAS 108 may transmit signaling to the network device 110 in order to provision a line for the SIM 104. As shown by reference number 208, the UE 106 may be powered on with the SIM 104. In other words, the SIM 104 may be associated with the UE 106 and then the UE 106 may be powered on. As shown by reference number 210, the UE 106 may provide profile (e.g., terminal profile) information to the SIM 104.

As shown by reference number 212, the SIM 104 may perform a bearer independent protocol (BIP) check. The BIP check may correspond to a communication protocol between the SIM 104 and the SIM OTA platform 112. The BIP check may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 214, the SIM 104 may perform a SIM OTA activation with the SIM OTA platform 112, which may be based on the BIP check. In this case, the SIM 104 may be able to communicate with the SIM OTA platform 112, which may be indicated by the BIP check.

As shown by reference number 216, the MTAS 108 may generate a flag, which may be in response to the SIM 104 being used on a certain number of voice calls and/or text messages within a certain time period. For example, the SIM 104 may be used to perform 800 voice calls in one day, which may cause the flag to be generated. The MTAS 108 may generate the flag based on a pattern based network detection. The SIM 104 may report, to the MTAS 108 and/or the network device 110, when the SIM 104 is being used to make a voice call or send a text message, which may allow the MTAS 108 to detect the certain number of voice calls and/or text messages within the certain time period and then generate the flag. The flag may indicate that the SIM 104 is potentially being used for unwanted behavior (e.g., making unwanted communications).

As shown by reference number 218, the MTAS 108 may transmit, to the SIM OTA platform 112, application trigger signaling, and as shown by reference number 220, the SIM OTA platform 112 may transmit, to the SIM 104 and based on the application trigger signaling, an application enabled signaling. As shown by reference number 222, the call control application may be enabled on the SIM 104, which may be based on the SIM wakeup invoked signaling. The call control application may serve to block subsequent communications (e.g., voice calls and/or text messages) by the UE 106, which may be based on an assumption that the subsequent communications are spam and/or scam related communications.

As shown by reference number 224, the SIM 104 may receive, from the UE 106, an invoke voice or short message service (SMS) (text) signaling, which may be based on a communication (e.g., a voice call or text message) to be initiated by the UE 106. As shown by reference number 226, the SIM 104 may block the UE 106 from performing the communication, which may be based on the call control application being enabled on the SIM 104. The SIM 104 may block the UE 106 from performing the communication based on the assumption that the UE 106 is associated with fraudulent activity. As shown by reference number 228, the SIM 104 may send, to the UE 106, a notification that the communication has been blocked.

As shown by reference number 230, the UE 106 may communicate with customer care via the network device 110. For example, the user 102 associated with the UE 106 may provide information indicating that the user 102 is a legitimate user and that the user 102 is not using the UE 106 to perform unwanted communications. In this example, the user 102 may be a non-fraudulent user that is flagged by mistake. When the UE 106 contacts customer care, the user 102 may be more likely to be legitimate, as fraudulent users are less likely to contact customer care. The network device 110 may determine that the UE 106 should not be blocked from performing the communication, which may be based on the information provided by the UE 106. In this example, even when the call control application is enabled, the UE 106 may still be connected to the network device 110, which may allow the UE 106 to communicate with customer care via the network device 110.

As shown by reference number 232, the network device 110 may send an indication to the SIM OTA platform 112, where the indication may indicate that the UE 106 should be allowed to perform the communication. As shown by reference number 234, the SIM OTA platform 112 may send disable application signaling to the SIM 104, which may cause the SIM 104 to disable the call control application. As shown by reference number 236, the SIM 104 may receive, from the UE 106, an invoke voice or SMS signaling, which may be based on a communication to be initiated by the UE 106. As shown by reference number 238, the SIM 104 may permit the UE 106 to perform the communication, which may be based on the call control application being disabled on the SIM 104. The SIM 104 may allow the UE 106 to perform the communication based on the assumption that the UE 106 is associated with non-fraudulent activity. As shown by reference number 240, the UE 106 may send signaling to the network device 110 to indicate that the communication was successful (e.g., the communication was actually sent by the UE 106).

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

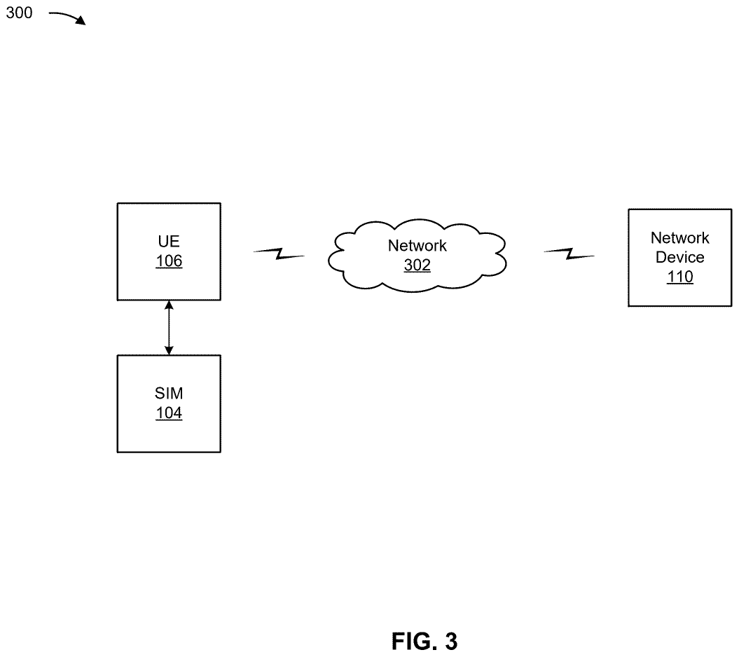

FIG. 3 is a diagram of an example environment 300 in which systems and/or methods described herein may be implemented. As shown in FIG. 3, environment 300 may include a UE 106 which may be associated with a SIM 104, a network device 110, and a network 302. Devices of environment 300 may interconnect via wired connections, wireless connections, or a combination of wired and wireless connections.

The UE 106 may include one or more devices capable of receiving, generating, storing, processing, and/or providing information associated with SIM based call control, as described elsewhere herein. The UE 106 may include a communication device and/or a computing device. For example, the UE 106 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an Internet of Things (IoT) device, or a similar type of device.

The network device 110 may include one or more devices capable of receiving, processing, storing, routing, and/or providing information associated with SIM based call control, as described elsewhere herein. The network device 110 may be an aggregated network node, meaning that the aggregated network node is configured to utilize a radio protocol stack that is physically or logically integrated within a single radio access network (RAN) node (e.g., within a single device or unit). The network device 110 may be a disaggregated network node (sometimes referred to as a disaggregated base station), meaning that the network device 110 is configured to utilize a protocol stack that is physically or logically distributed among two or more nodes (such as one or more central units (CUs), one or more distributed units (DUs), or one or more radio units (RUs)). The network device 110 may include, for example, a New Radio (NR) base station, a long-term evolution (LTE) base station, a Node B, an eNB, a gNodeB, an access point, a transmission reception point (TRP), a DU, an RU, a CU, a mobility element of a network, a core network node, a network element, a network equipment, and/or a RAN node. The network device 110 may be a packet data network gateway (PGW), a home subscriber server (HSS), or another type of network element.

The network 302 may include one or more wired and/or wireless networks. The network 302 may include a terrestrial network. For example, the network 302 may include a cellular network (e.g., a Fifth Generation (5G) network, a Fourth Generation (4G) network, a Long Term Evolution (LTE) network, a Third Generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 302 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

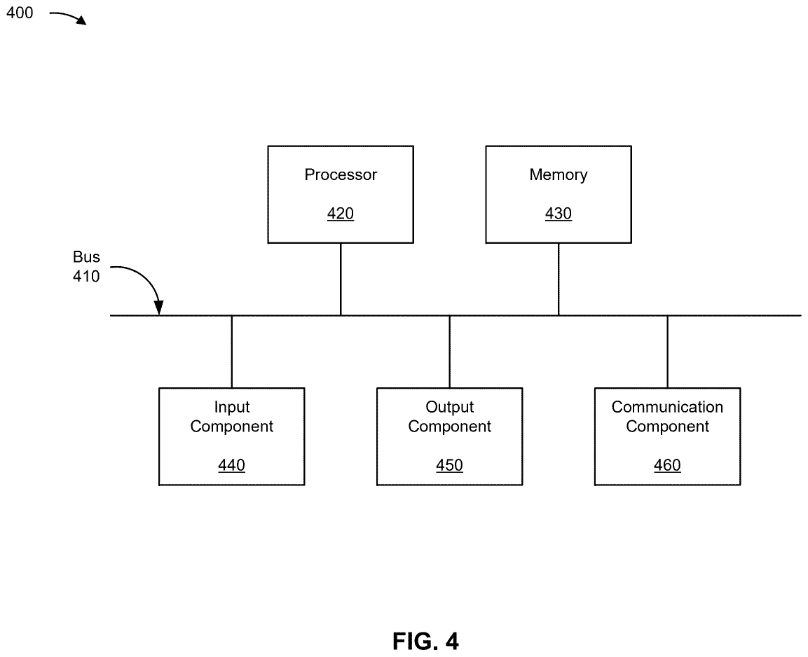

FIG. 4 is a diagram of example components of a device 400 associated with SIM based call control. The device 400 may correspond to a device, such as a SIM (e.g., SIM 104) or a UE (e.g., UE 106). In some implementations, the device may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

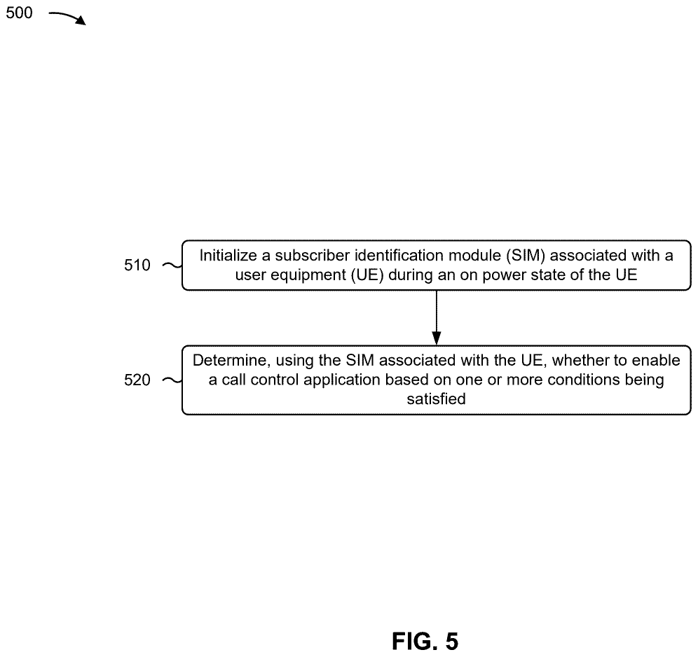

FIG. 5 is a flowchart of an example process 500 associated with SIM based call control. In some implementations, one or more process blocks of FIG. 5 may be performed by a device, such as a SIM (e.g., SIM 104) or a UE (e.g., UE 106). In some implementations, one or more process blocks of FIG. 5 may be performed by another device or a group of devices separate from or including the device. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include initializing the SIM associated with the UE during an on power state of the UE (block 510). The SIM may be associated with a call control application that is disabled. The UE may be powered on with the SIM inserted in the UE. The SIM may be a prepaid SIM. The SIM may be manufactured with the call control application disabled.

As shown in FIG. 5, process 500 may include determining, using the SIM associated with the UE, whether to enable the call control application based on one or more conditions being satisfied (block 520). The SIM may block the UE from performing a communication when the call control application is enabled. The one or more conditions may be satisfied based on a number of communications initiated by the UE during a period of time satisfying a threshold. The number of communications may include voice calls and/or text messages. The call control application may be enabled or disabled to prevent the SIM from being used to launch spam or scam related communications.

In some implementations, the SIM may perform a BIP check to determine whether the SIM is able to communicate with a SIM OTA platform. In some implementations, the SIM may receive, from the SIM OTA platform, signaling to enable the call control application. The signaling to enable the call control application may be based on a flag generated for the UE. The flag may be generated based on the one or more conditions being satisfied. The SIM may enable the call control application based on the signaling. In some implementations, the SIM may maintain a connection with a network device when the call control application is enabled. In some implementations, the SIM may receive, from the UE, signaling to invoke a first communication. The SIM may block the first communication based on the call control application being enabled. The SIM may send, to the UE, a notification that the first communication has been blocked. In some implementations, the SIM may receive, from the SIM OTA platform, signaling to disable the call control application. The SIM may disable the call control application based on the signaling. The SIM may receive, from the UE, signaling to invoke a second communication. The SIM may approve the second communication based on the call control application being disabled.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
initializing a subscriber identification module (SIM) associated with a user equipment (UE) during an on power state of the UE, wherein the SIM is associated with a call control application that is disabled; and
determining, using the SIM associated with the UE, whether to enable the call control application based on one or more conditions being satisfied, wherein the SIM blocks the UE from performing a communication when the call control application is enabled.

2. The method of claim 1, wherein the one or more conditions are satisfied based on a number of communications initiated by the UE during a period of time satisfying a threshold.

3. The method of claim 1, wherein the communication is associated with a voice call or a text message.

4. The method of claim 1, further comprising:
performing, using the SIM, a bearer independent protocol (BIP) check to determine whether the SIM is able to communicate with a SIM over-the-air (OTA) platform.

5. The method of claim 4, further comprising:
receiving, by the SIM from the SIM OTA platform, signaling to enable the call control application, wherein the signaling to enable the call control application is based on a flag generated for the UE, and wherein the flag is generated based on the one or more conditions being satisfied; and
enabling, by the SIM, the call control application based on the signaling.

6. The method of claim 5, further comprising:
maintaining a connection with a network device when the call control application is enabled.

7. The method of claim 5, further comprising:
receiving, by the SIM from the UE, signaling to invoke a first communication;
blocking, by the SIM, the first communication based on the call control application being enabled; and
sending, by the SIM to the UE, a notification that the first communication has been blocked.

8. The method of claim 7, further comprising:
receiving, by the SIM from the SIM OTA platform, signaling to disable the call control application;
disabling, by the SIM, the call control application based on the signaling;
receiving, by the SIM from the UE, signaling to invoke a second communication; and
approving, by the SIM, the second communication based on the call control application being disabled.

9. The method of claim 1, wherein the SIM is a prepaid SIM.

10. The method of claim 1, wherein the call control application is enabled or disabled to prevent the SIM from being used to launch spam or scam related communications.

11. A subscriber identification module (SIM) associated with a user equipment (UE), the SIM comprising:
one or more components configured to:
initialize the SIM during an on power state of the UE, wherein the SIM is associated with a call control application that is disabled; and
determine whether to enable the call control application based on one or more conditions being satisfied, wherein the SIM blocks the UE from performing a communication when the call control application is enabled.

12. The SIM of claim 11, wherein the one or more conditions are satisfied based on a number of communications initiated by the UE during a period of time satisfying a threshold, and wherein the communications are associated with voice calls or text messages.

13. The SIM of claim 11, wherein the one or more components are further configured to:
perform a bearer independent protocol (BIP) check to determine whether the SIM is able to communicate with a SIM over-the-air (OTA) platform.

14. The SIM of claim 13, wherein the one or more components are further configured to:
receive, from the SIM OTA platform, signaling to enable the call control application, wherein the signaling to enable the call control application is based on a flag generated for the UE, and wherein the flag is generated based on the one or more conditions being satisfied; and
enable the call control application based on the signaling.

15. The SIM of claim 14, wherein the one or more components are further configured to:
maintain a connection with a network device when the call control application is enabled.

16. The SIM of claim 14, wherein the one or more components are further configured to:
receive, from the UE, signaling to invoke a first communication;
block the first communication based on the call control application being enabled; and
send, to the UE, a notification that the first communication has been blocked.

17. The SIM of claim 16, wherein the one or more components are further configured to:
receive, from the SIM OTA platform, signaling to disable the call control application;
disable the call control application based on the signaling;
receive, from the UE, signaling to invoke a second communication; and
approve the second communication based on the call control application being disabled.

18. The SIM of claim 11, wherein the SIM is a prepaid SIM.

19. The SIM of claim 11, wherein the call control application is enabled or disabled to prevent the SIM from being used to launch spam or scam related communications.

20. A non-transitory computer-readable medium storing a set of instructions, the set of instructions comprising:
one or more instructions that, when executed by one or more components of a subscriber identification module (SIM) associated with a user equipment (UE), cause the SIM to:
initialize the SIM during an on power state of the UE, wherein the SIM is associated with a call control application that is disabled; and
determine whether to enable the call control application based on one or more conditions being satisfied, wherein the SIM blocks the UE from performing a communication when the call control application is enabled.
